(19) United States
(12) Patent Application Publication
(10) Pub. No.: US 2008/0144522 A1
(43) Pub. Date: Jun. 19, 2008

(54) APPARATUS AND METHOD FOR COMMUNICATING CHANNEL INFORMATION IN RELAY WIRELESS COMMUNICATION SYSTEM

(75) Inventors: Young-Bin CHANG, Anyang-si (KR); Chang-Yoon Oh, Yongin-si (KR); Hyun-Jeong Kang, Yongin-si (KR); Jae-Weon Cho, Suwon-si (KR); Hyoung-Kyu Lim, Seoul (KR); Sung-Jin Lee, Seoul (KR); Pan-Yuh Joo, Seoul (KR); Eun-Taek Lim, Suwon-si (KR); Yong-Ho Park, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd.

(21) Appl. No.: 11/945,696

(22) Filed: Nov. 27, 2007

(30) Foreign Application Priority Data
Nov. 27, 2006 (KR) 2006-0117443

(51) Int. Cl. G06F 11/30

(52) U.S. Cl. 370/252

(57) ABSTRACT

An apparatus and method for communicating channel information in a relay wireless communication system are provided. A Base Station (BS) apparatus includes a message generator for generating a channel measurement request message to be transmitted to a Relay Station (RS) when the RS is connected; a Transmit (TX) modem for performing a physical layer processing on a message generated by the message generator and for transmitting the processed message; a message analyzer for analyzing a channel measurement response message received from the RS and for obtaining channel estimation information; and a scheduler for performing data scheduling by using the channel estimation information for a predetermined duration corresponding to a plurality of frames.

### PRIORITY

This application claims priority under 35 U.S.C. § 119(a) to a Korean patent application filed in the Korean Intellectual Property Office on Nov. 27, 2006 and assigned Serial No. 2006-0117443, the entire disclosure of which is hereby incorporated by reference.

### BACKGROUND OF THE INVENTION

1. Field of the Invention

The present invention relates to an apparatus and method for communicating channel information in a wireless communication system. More particularly, the present invention relates to an apparatus and method for communicating channel information of a Relay Station (RS) in a relay wireless communication system.

2. Description of the Related Art

In general, voice services have been a primary concern in the development of communication systems, and in addition to the voice service, provision of various multimedia services as well as data services is becoming increasingly important when developing the communication systems. However, voice-based communication systems have failed to satisfy user demand due to a relatively small transmission bandwidth and expensive service fees. Moreover, the advance of communication technologies and the growth of demand for Internet services have resulted in an increased need for a communication system capable of effectively providing the Internet services. To cope with such user demand, a Broadband Wireless Access (BWA) system has been introduced for effective provision of broadband Internet services.

The BWA system uses an Orthogonal Frequency Division Multiplexing (OFDM)/Orthogonal Frequency Division Multiple Access (OFDMA) method for a physical channel. That is, the BWA system transmits a physical channel signal by using a plurality of sub-carriers, and thus high-speed data transmission can be achieved.

In the BWA system, a Base Station (BS) performs data scheduling by using a Channel Quality Indicator (CQI), which is fed back from a Mobile Station (MS).

FIG. 1 is a diagram illustrating communication of channel information in a conventional wireless communication system.

Referring to FIG. 1, a BS transmits a pilot signal and a data signal to an MS. To ensure reliable communication between the BS and the MS, the MS reports a signal strength of the pilot signal or a Signal to Interference and Noise Ratio (SINR) value to the BS at a time requested by the BS, and then the BS performs data scheduling by using the reported channel information.

Since the MS moves at a specific speed as shown in FIG. 1, the MS must report the channel information. That is, it is difficult for the BS to predict changes in a wireless channel when the location and speed of the MS changes, and thus the MS must continuously or periodically report the channel information to the BS.

FIG. 2 illustrates a data scheduling procedure using channel information in a conventional wireless communication system.

Referring to FIG. 2, during an initial network entry, an MS and a BS perform a registration process for data communication, in step 201. After the registration process, the MS and the BS perform a Dynamic Service Addition (DSA) process, in step 203. In this step, the BS allocates a service IDentification (ID) (i.e., connection ID) to the MS so that the MS can perform data communication.

Thereafter, the BS requests channel information to the MS, and the MS feeds back the channel information to the BS. The BS may obtain the channel information by using two methods as follows.

In a first method, the BS transmits to the MS a REPort-REQuest (REP-REQ) message for requesting the channel information, in step 205. Then, the MS estimates a channel by using the REP-REQ message and transmits a REPort-ReSPonse (REP-RSP) message, including the estimated channel value to the BS, in step 207. The REP-RSP message includes information on a physical frame in which channel estimation starts, information on a frame duration in which channel estimation is performed, and a Received Signal Strength Indicator (RSSI) value or an SINR value, which results from channel estimation performed during the frame duration.

In a second method, the BS transmits, to the MS, a CQI allocation message (i.e., a CQI allocation Information Element (IE) or a CQI control IE) for allocating a CQI channel, in step 205. The CQI allocation message includes information on a start physical frame, information on a frame duration, and information on a frame period in which channel information is reported. Then, the MS estimates a channel by using the information included in the CQI allocation message and reports the estimated channel value to the BS by using a CQI feedback physical channel, in step 207.

Upon obtaining the channel information, the BS performs data scheduling by using the channel information, and according to the scheduling result, the BS generates and broadcasts resource allocation information (i.e., DownLink (DL)-MAP/UpLink (UL)-MAP, in step 209. Thereafter, the BS and the MS perform data communication according to the resource allocation information, in step 211. In this step, the MS receives DL data by using the DL-MAP and transmits UL data by using the UL-MAP.

Since the MS is mobile, the aforementioned steps 205 to 211 must be periodically performed. If the channel information of the MS is not periodically updated, reliable data communication cannot be achieved between the BS and the MS.

Meanwhile, throughput and coverage are limited when a mobile communication system operates in a high frequency band due to a high path-loss. To address this problem, recently, a multi-hop relay scheme has actively been researched. In the multi-hop relay scheme, data is relayed using a Relay Station (RS), thereby reducing a path loss. Thus it is possible to deliver a signal to an MS at a distance far from a BS.

To perform data scheduling between the BS and the RS, the BS must obtain channel information on the RS. Unlike the aforementioned scheduling between the BS and the MS, the data scheduling between the BS and the RS is characterized as follows.

First, unlike the MS, the RS has no mobility, and is thus highly likely to be located in a Line Of Sight (LOS) position with respect to the BS. That is, there is no significant change in a wireless channel between the BS and the RS. Therefore, it is not necessary to frequently perform channel estimation (or channel information update) as in the conventional case.

Second, when few RSs exist inside a cell managed by the BS and when a plurality of users communicate through the RSs, an area (or resource) occupied by data transmitted from the BS to the RSs is larger than that occupied by data transmitted from the BS to one MS. Thus, it is more effective to report an accurate Carrier to Interference and Noise Ratio (CINR) value for the entire time and frequency domains rather than to report an RSSI value of an input signal, an average CINR value of a pilot signal, or a CINR value for only some of the frequency bands having a good channel state.

As described above, the wireless communication system using the multi-hop relay scheme has many problems when a channel report method (or data scheduling method) between a BS and an MS is applied without alteration between the BS and an RS. Therefore, there is a need for a method of effectively performing data scheduling between the BS and the RS.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for effectively performing data scheduling between a Base Station (BS) and a Relay Station (RS) in a multi-hop relay mobile communication system.

Another aspect of the present invention is to provide an apparatus and method for periodically updating channel information of an RS with a long period of time in a multi-hop relay mobile communication system.

Another aspect of the present invention is to provide an apparatus and method in which channel information of an RS is reported to a BS during an initial network entry and the channel information is used for data scheduling for a long period of time in a multi-hop relay mobile communication system.

According to an aspect of the present invention, a BS apparatus in a relay wireless communication system is provided. The BS includes a message generator for generating a channel measurement request message to be transmitted to an RS when the RS is connected; a Transmit (TX) modem for performing a physical layer processing on a message generated by the message generator and for transmitting the processed message; a message analyzer for analyzing a channel measurement response message received from the RS and for obtaining channel estimation information; and a scheduler for performing data scheduling by using the channel estimation information for a predetermined duration corresponding to a plurality of frames.

According to another aspect of the present invention, an RS apparatus in a relay wireless communication system is provided. The RS includes a message analyzer for analyzing a channel measurement request message received from a BS; a channel estimator for estimating a channel for an entire frequency band according to the channel measurement request message; a message generator for generating a channel measurement response message, including channel estimation information provided from the channel estimator; and a TX modem for converting a message provided from the message generator according to a transmission protocol and for transmitting the converted message, wherein the channel estimation information reported to the BS is used in data scheduling for a frame duration corresponding to a plurality of frames.

According to another aspect of the present invention, a communication method of a BS in a relay wireless communication system is provided. The method includes transmitting a channel measurement request message to an RS when the RS is connected; analyzing a channel measurement response message received from the RS and obtaining channel estimation information; and allowing the channel estimation information to be used in data scheduling for a predetermined long period of time.

According to another aspect of the present invention, a communication method of an RS in a relay wireless communication system is provided. The method includes receiving a channel measurement request message from a BS; estimating a channel for an entire frequency band according to the channel measurement request message; and generating a channel measurement response message including channel estimation information and transmitting the generated message to the BS, wherein the channel estimation information reported to the BS is used in data scheduling for a frame duration corresponding to a plurality of frames.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 is a diagram illustrating communication of channel information in a conventional wireless communication system;

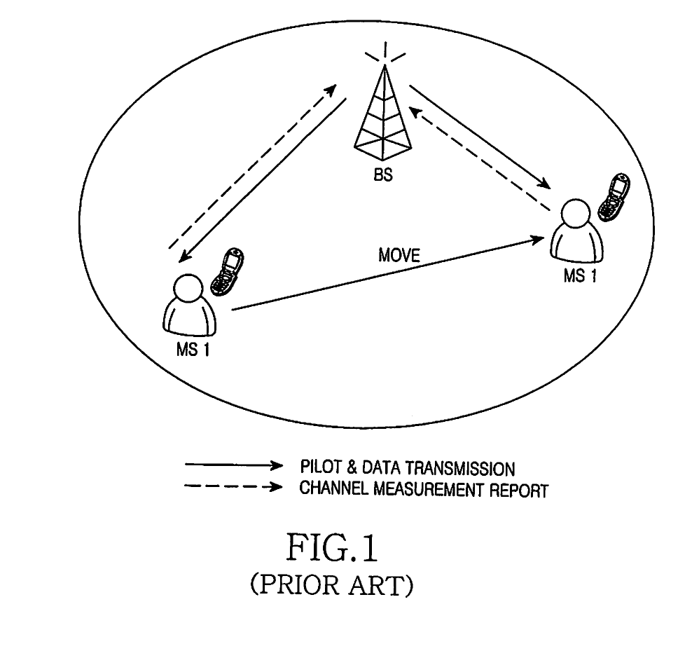

FIG. 2 illustrates a data scheduling procedure using channel information in a conventional wireless communication system;

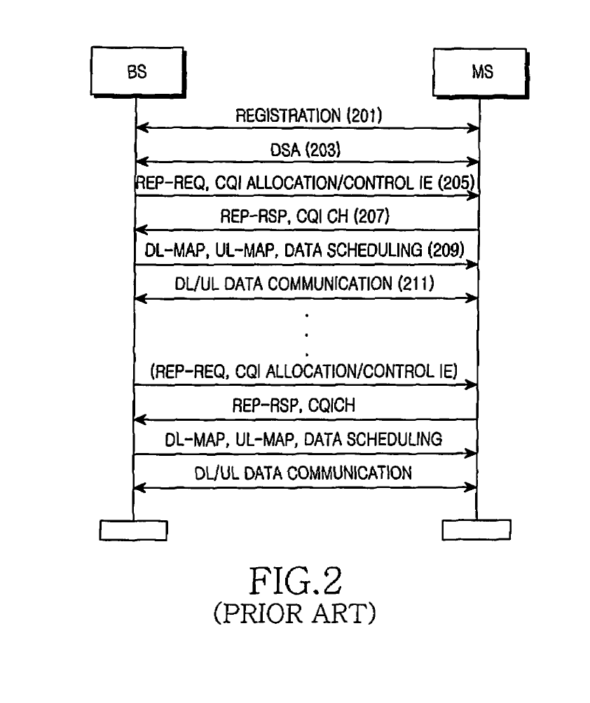

FIG. 3 is a diagram illustrating a configuration of a multi-hop relay system;

FIG. 4 illustrates a communication procedure between a Base Station (BS) and a Relay Station (RS) in a multi-hop relay mobile communication system according to an embodiment of the present invention;

FIG. 5 illustrates an operation of a BS in a multi-hop relay mobile communication system according to an embodiment of the present invention;

FIG. 6 illustrates an operation of an RS in a multi-hop relay mobile communication system according to an embodiment of the present invention;

FIG. 7 is a block diagram illustrating a structure of a BS in a multi-hop relay mobile communication system according to an embodiment of the present invention; and

FIG. 8 is a block diagram illustrating a structure of an RS in a multi-hop relay mobile communication system according to an embodiment of the present invention.

### DETAILED DESCRIPTION OF THE PREFERRED EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions will be omitted for clarity and conciseness.

Hereinafter, a data scheduling method performed between a Base Station (BS) and a Relay Station (RS) in a multi-hop relay mobile communication system will be described.

The multi-hop relay mobile communication system is a Broadband Wireless Access (BWA) communication system employing an Orthogonal Frequency Division Multiplexing (OFDM) scheme and an Orthogonal Frequency Division Multiple Access (OFDMA) scheme.

Although the BWA system is explained through examples in the following description, the present invention may also apply to another cellular-based communication systems as long as a multi-hop relay scheme is used.

The RS is generally classified into a fixed RS having a negligible mobility, a nomadic RS (e.g., laptop computer) having a nomadic characteristic, and a mobile RS having a mobility similar to a Mobile Station (MS). The RS described in the present invention has a channel state that does not significantly change, such as the fixed RS or the nomadic RS. Since channel variation is not significant in such an RS, channel information is reported to the BS during an initial establishment (or initial network entry), and the initially reported channel information is used in data scheduling by the BS for a long period of time. That is, since the initially reported channel information is used in data scheduling as long as there is no channel variation between the BS and the RS, it is possible to remove an overhead that may be generated when the channel information is frequently reported.

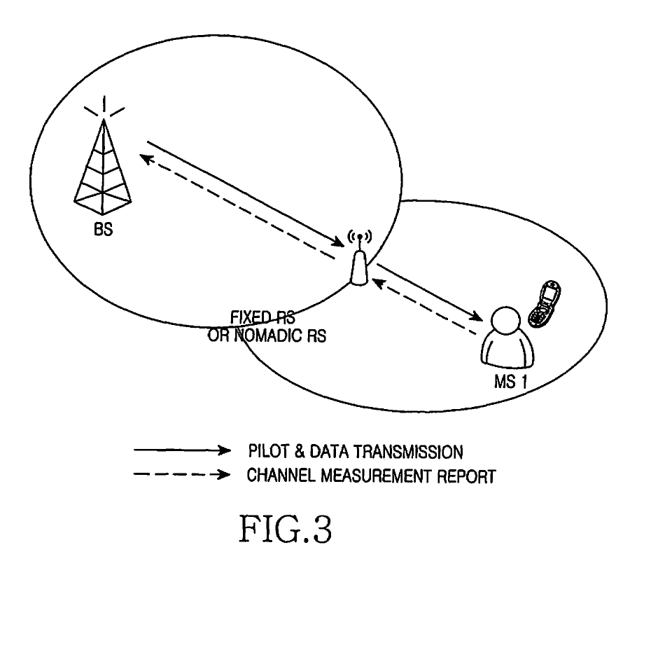

FIG. 3 is a diagram illustrating a configuration of a multi-hop relay system.

Referring to FIG. 3, an MS 1 is located outside a coverage area of a BS and thus the MS 1 cannot directly communicate with the BS. Therefore, the MS1 is connected to the BS via an RS. The RS is located between the BS and the MS so that data received from the BS is relayed to the MS and data received from the MS is relayed to the BS.

For data scheduling between the BS and the RS, the RS estimates a channel by using a pilot signal received from the BS and then reports the estimated channel value to the BS. Then, the MS estimates a channel by using a pilot signal received from the RS and then reports the estimated channel value to the RS. If data scheduling for the MS is managed by the RS, the RS performs data scheduling between the RS and the MS by using the channel information reported from the MS. If data scheduling for the MS is managed by the BS, the RS relays to the BS the channel information reported from the MS.

According to the present invention, the RS reports the channel information to the BS during an initial establishment, and the BS uses the initially reported channel information in data scheduling for a long period of time (at least one or more frames).

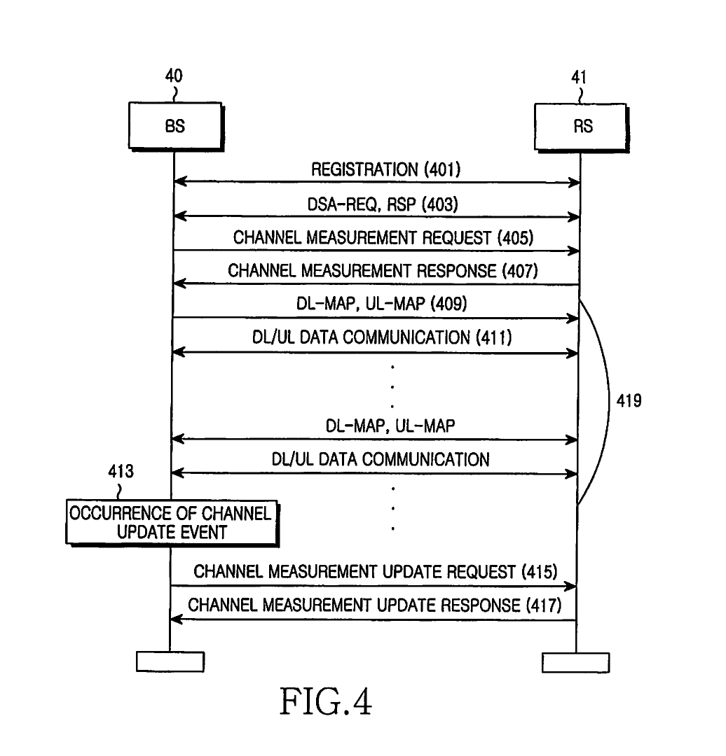

FIG. 4 illustrates a communication procedure between a BS and an RS in a multi-hop relay mobile communication system according to an embodiment of the present invention.

Referring to FIG. 4, during an initial network entry of an RS 41, the RS 41 and a BS 40 perform a registration process for data communication, in step 401. After the registration process, the RS 41 and the BS 40 perform a Dynamic Service Addition (DSA) process, in step 403 where the BS 40 allocates a service ID (i.e., connection ID) to the RS 41 so that the MS can perform data communication.

Upon completing the aforementioned processes for preparing communication, the BS 40 transmits to the RS 41 a channel measurement request message for requesting channel estimation, in step 405. The channel measurement request message may include a start frame number for starting channel estimation, a duration for performing channel estimation, a report period, a report type, etc.

The RS 41 estimates a channel by using information included in the channel measurement request message and transmits a channel measurement response message including channel estimation information to the BS 40, in step 407. For example, the channel measurement response message may include a channel estimation value (e.g., SINR value, CINR value, etc.) and a frame number for performing channel estimation. Furthermore, the channel measurement response message may include channel estimation values for all sub-bands (e.g., Adaptive Modulation and Coding (AMC) band), or channel estimation values for selected sub-bands satisfying a specific rule, or channel estimation values for a predetermined number of sub-bands having a poor channel state.

As such, the BS 40 obtains channel information of the RS 41 and then performs data scheduling by using the channel information. Then, according to the scheduling result, the BS 40 generates and broadcasts resource allocation information (i.e., DL-MAP/UL-MAP), in step 409. Thereafter, the BS 40 and the RS 41 perform data communication according to the resource allocation information, in step 411. In this step, the RS 41 receives DL data by using the DL-MAP and transmits UL data to the BS 40 by using the UL-MAP.

The channel information obtained in steps 405 and 407 is used for a long period of time in data scheduling as long as a specific event does not occur, in step 419. Since a channel state does not significantly change in the RS 41, the BS 40 may allocate the same resource to the RS 41 for a long period of time instead of allocating a new resource to the RS 41 for every frame. In this case, instead of transmitting a resource allocation message (e.g., MAP IE) to the RS 41, the BS 40 may transmit the resource allocation message only once when an allocation resource changes.

While data communication is performed between the BS 40 and the RS 41, a specific event for requesting channel information update may occur, in step 413. The specific event may occur when a location of the RS 41 changes or when an obstacle is disposed between the RS 41 and the BS 40. The BS 40 may update channel information by checking a predetermined channel information update period (e.g., one month, one year, etc.).

If it is determined that the channel information of the RS 41 must be updated, the BS 40 transmits to the RS 41 a channel measurement update request message for requesting channel information update, in step 415. Then, the RS 41 estimates a channel by using the received channel measurement update request message and transmits to the BS 40 a channel measurement update response message including channel estimation information, in step 417. Thereafter, the BS 40 uses the obtained channel information in data scheduling as long as the specific event does not occur.

In the aforementioned embodiment of FIG. 4, the RS 41 measures and reports a channel upon receiving an update request from the BS 40. However, in another embodiment, the RS 41 may detect channel variation, and when it is determined that channel information update is necessary, the RS 41 may transmit the channel measurement update response message to the BS 40 without having to receive the update request from the BS 40.

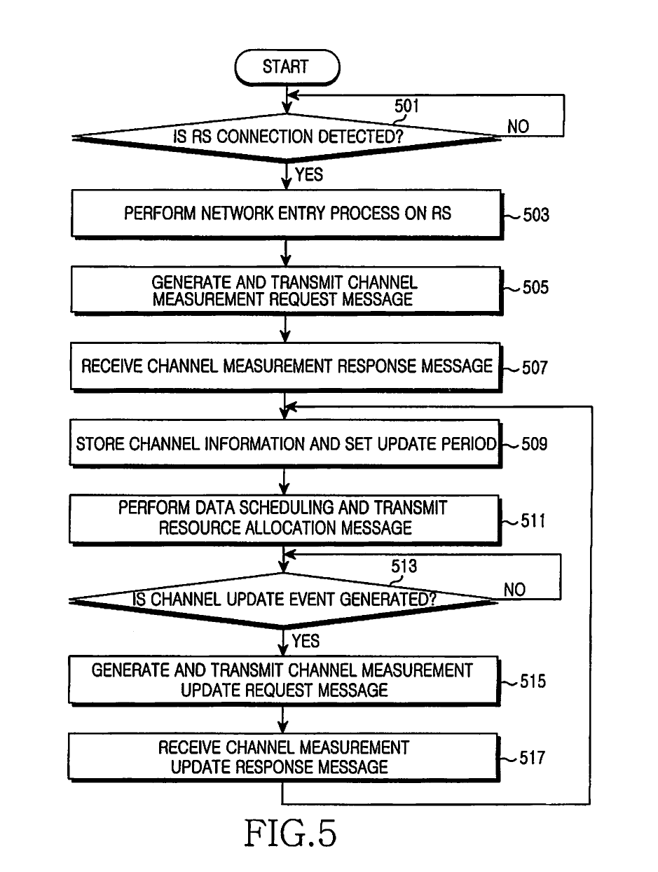

FIG. 5 illustrates an operation of a BS in a multi-hop relay mobile communication system according to an embodiment of the present invention.

Referring to FIG. 5, in step 501, the BS checks whether an RS access is detected. Upon detecting an RS access, in step 503, the BS performs a network entry process on the RS. When the RS access is detected, the BS performs the network entry process on the RS similar to the network entry process of an MS. For example, the BS may perform a ranging process, a basic capability negotiation process, an authorization process, a registration process, etc.

After completing the network entry process, in step 505, the BS transmits to the RS a channel measurement request message for requesting channel estimation. The channel measurement request message may include measurement duration information and measurement period information. For example, the channel measurement request message may include at least one element described in Table 1 to Table 3 below.

TABLE 1

| Name | Value |
|---|---|
| Start frame | start frame number for starting channel measurement |
| number | |
| Duration | channel measurement duration information (unit: |
| | the number of frames) |

TABLE 2

| Name | Value |
|---|---|
| Start frame number | start frame number for starting channel measurement |
| End frame number | end frame number for ending channel measurement |

TABLE 3

| Name | Value |
|---|---|
| Measurement | channel measurement period information (unit: |
| Period | the number of frames) |

As shown in Table 1, the BS may inform the RS of a frame for starting channel measurement and a channel measurement duration. Further, a frame for staring channel measurement and a frame for ending channel measurement may further be informed as shown in Table 2. Furthermore, in addition to elements described in Table 1 and Table 2, an element described in Table 3 may further be informed. When a measurement period is included in the channel measurement request message as shown in Table 3, the RS periodically reports a channel state to the RS with a predetermined period.

After transmitting the channel measurement request message, in step 507, the BS receives from the RS a channel measurement response message including channel estimation information. The channel measurement response message may include not only a channel estimation value but also a frame number for performing channel measurement as described in Table 4 or Table 5 below.

TABLE 4

| Name | Value |
|---|---|
| Channel measurement value | |
| Channel measurement | unique number of frame for performing |
| Frame Number | channel measurement |

TABLE 5

| Name | Value |
|---|---|
| Channel measurement value | |
| Channel measurement | offset value between time for receiving |
| Frame Sequence number | channel measurement request message and |
| | frame for performing channel measurement |

As shown in Table 4 and Table 5, the channel measurement response message may include a channel estimation value (e.g., CINR) and information on a frame for performing channel estimation. As a result, the BS can recognize an amount of channel variation in a time axis.

Upon receiving the channel measurement response message, in step 509, the BS extracts channel information from the channel measurement response message, stores the channel information, and sets a channel information update period for the RS. The channel information update period is set to a long period of time (e.g., one month, one year, etc.) under the assumption that a channel variation is not significant between the BS and the fixed RS.

In step 511, the BS performs data scheduling on the RS by using the stored channel information, and transmits to the RS a resource allocation message resulted from the data scheduling. Thereafter, the BS and the RS perform communication by using an allocation resource indicated by the resource allocation message.

During the communication with the RS, in step 513, the BS checks whether a channel information update event for the RS occurs. For example, the event may occur when a time corresponding to the channel information update period has elapsed, or when an obstacle is disposed between the BS and the RS, or when quality of signal (i.e., reception strength, data error rate, etc.) received from the RS is detected to be below a specific reference value.

When the channel information update event occurs, in step 515, the BS transmits to the RS a channel measurement update request message for requesting a channel information update. In step 517, the BS receives, from the RS, a channel measurement update response message including channel estimation information. Upon receiving the channel measurement update response message, the procedure returns to step 509, and thus the BS performs the subsequent steps again. The channel measurement update request message may have a format similar to that of the channel measurement request message. The channel measurement update response message may have a format similar to that of the channel measurement response message.

In the aforementioned embodiment, the RS estimates a channel for an entire frequency band when a channel measurement (or channel measurement update) is requested from the BS. In this case, the entire frequency band may be divided into a specific number of sub-bands (e.g., AMC bands), and channel estimation may be performed for each sub-band. The RS may report channel estimation values for all of the sub-bands to the BS, or channel estimation values for selected sub-bands satisfying a specific rule, or channel estimation values for a specific number of selected sub-bands (e.g., 5 sub-band) having a poor channel state. In this case, the channel measurement response message (or channel measurement update response message) may include an element described in Table 6, Table 7, or Table 8.

TABLE 6

| Name | Value |
|---|---|
| Band AMC | 60 bits indicate CINR values for a total of N sub-bands. |
| report for | |
| Relay | |

TABLE 7

| Name | Value |
|---|---|
| Band AMC | First 12 bits indicate bitmap information on sub-bands |
| report for | having a poor channel state, and subsequent 25 bits |
| Relay | indicate CINR values for sub-bands having a poor |
| | channel state. |

When the RS reports bands having a poor channel state to the BS as shown in Table 7, the BS may first allocate resources to the RS by excluding the bands having a poor channel state.

TABLE 8

| Name | Value |
|---|---|
| Band AMC | First 12 bits indicate bitmap of all sub-bands, and |
| report for | subsequent xx bits indicate CINR values as many as the |
| Relay | number of sub-bands indicated by ‘1’. In this case, |
| | 5-bit CINR values are reported for each sub-band having a |
| | bitmap of ‘1’. |

In Table 6 to Table 8, the number of entire sub-bands is assumed to be 12, and a CINR value is assumed to be composed of 5 bits. A sub-band for reporting the CINR value is assigned by using a bitmap. All CINR values (i.e., 5-bit information) for sub-bands, each having a bitmap of ‘1’, are reported to the BS. For example, the RS may compare a measured CINR value with a threshold, and if the measured CINR value of a sub-band is greater than the threshold, the RS may report channel estimation values (i.e., CINR values) to the RS

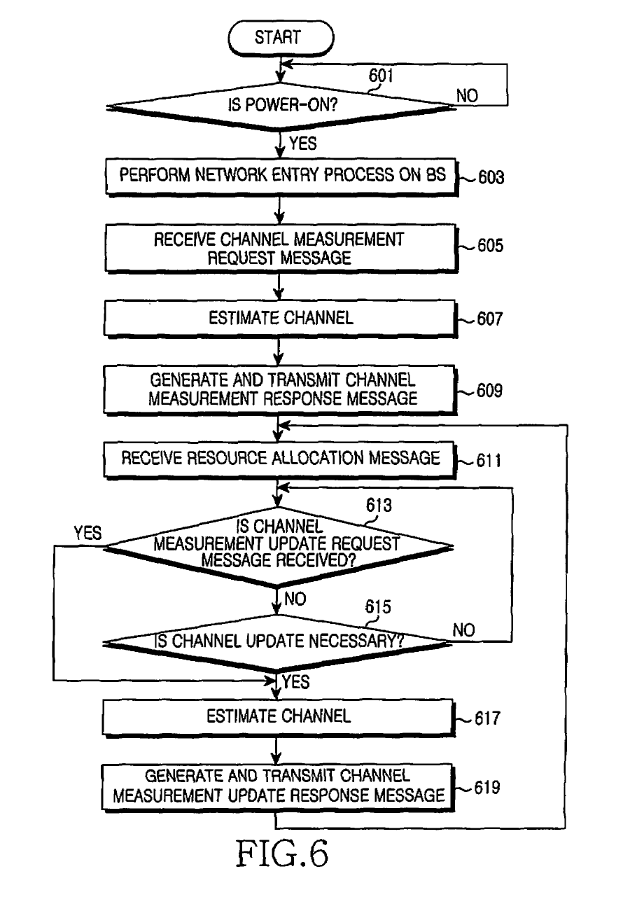

FIG. 6 is a flowchart illustrating an operation of an RS in a multi-hop relay mobile communication system according to an embodiment of the present invention.

Referring to FIG. 6, in step 601, the RS checks whether a power-on is detected. Upon detecting the power-on, in step 603, the RS performs scanning so as to select a BS to be connected, and performs an initial network entry process on the selected BS. For example, the RS may be connected to the BS by performing a ranging process, a basic capacity negotiation process, an authorization process, a registration process, etc.

After completing initial network entry, in step 605, the RS receives a channel measurement request message from the BS. Upon receiving the channel measurement request message, in step 607, the RS estimates a channel according to information included in the channel measurement request message. In this case, the RS performs accurate channel estimation for an entire frequency band. Thereafter, in step 609, the RS generates a channel measurement response message including the channel estimation information and transmits the channel measurement response message to the BS.

In step 611, the RS receives a resource allocation message from the BS. Thereafter, the BS communicates with the BS by using a resource indicated by the resource allocation message. During communication with the BS, in step 613, the RS checks whether a channel measurement update request message is received from the BS.

Upon receiving the channel measurement update request message, the procedure proceeds to step 617, and thus the RS performs accurate channel estimation for the entire frequency band according to the channel measurement update request message. If the channel measurement update request message is not detected, in step 615, the RS determines if a channel update is necessary.

For example, the RS may periodically measure an RSSI value or an SINR value of a signal received from the BS, compute a difference between this measured value and a previously measured value, and if the difference is greater than or equal to a threshold, determine that a channel update is necessary. Alternatively, the RS may periodically measure a Bit Error Rate (BER) or a Frame Error Rate (FER) of data received from the BS, compute a difference between this measured value and a previously measured value, and if the difference is greater than or equal to a threshold, determine that the channel update is necessary.

If the channel update is not necessary, the procedure returns to step 614, and thus the RS performs the subsequent steps again. If the channel update is necessary, in step 617, the RS performs accurate channel estimation for the entire frequency band. In step 619, the RS generates a channel measurement update response message including the channel estimation information and transmits the channel measurement update response message to the BS. Then, returning back to step 611, the RS repeats the subsequent steps.

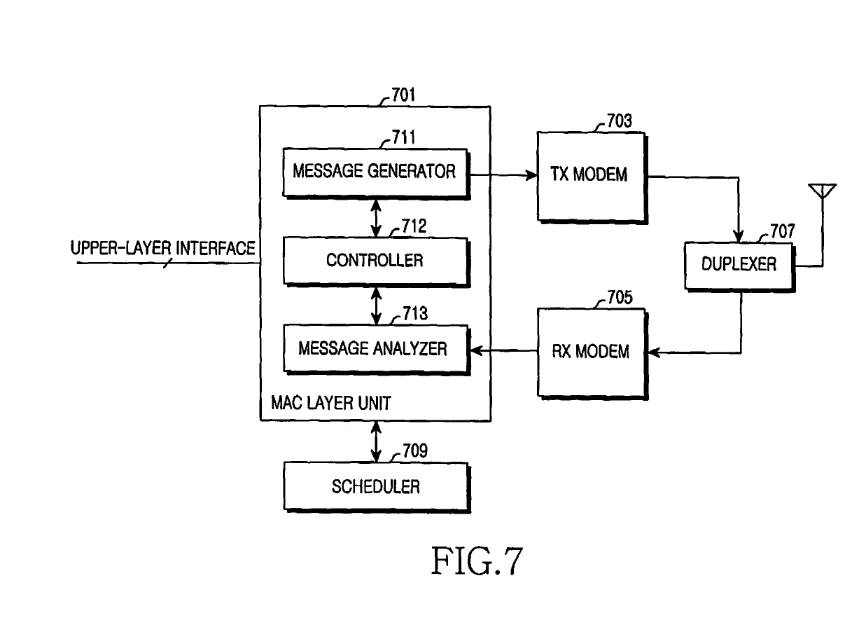

FIG. 7 is a block diagram illustrating a structure of a BS in a multi-hop relay mobile communication system according to an embodiment of the present invention.

Referring to FIG. 7, the BS includes a Media Access Control (MAC) layer unit 701 connected to an upper layer, a Transmit (TX) modem 703, a Receive (RX) modem 705, a duplexer 707, and a scheduler 709. The MAC layer unit 701 includes a message generator 711, a controller 712, and a message analyzer 713.

Referring to FIG. 7, the MAC layer unit 701 receives TX data from the upper layer (e.g., Internet Protocol (IP) layer unit), processes the TX data according to an access type of the TX modem 703, and delivers the TX data to the TX modem 703. The MAC layer unit 701 receives RX data from the RX modem 705, processes the RX data according to an access type of the upper layer, and delivers the RX data to the upper layer. Further, the MAC layer unit 701 generates a transmission control message required for signaling and analyzes a reception control message delivered from the RX modem 705.

The TX modem 703 includes a channel coding block, a modulation block, and a Radio Frequency (RF) transmission block. Further, the TX modem 703 converts data (i.e., burst data) received from the MAC layer unit 701 into a format suitable for RF transmission and then delivers the converted data to the duplexer 707. The channel coding block includes a channel encoder, an interleaver, and a modulator. The modulation block includes an Inverse Fast Fourier Transform (IFFT) operator for carrying TX data over a plurality of orthogonal sub-carriers. The RF transmission block includes a frequency converter and a filter.

The RX modem 705 includes an RF receiving block, a demodulation block, and a channel decoding block. Further, the RX modem 705 restores data from an RF signal received from the duplexer 707 and delivers the restored data to the MAC layer unit 701. The RF receiving block includes a frequency converter and a filter. The demodulation block includes an FFT operator for extracting data carried over sub-carriers. The channel decoding block includes a demodulator, a de-interleaver, and a channel decoder.

The duplexer 707 transmits to the RX modem 705 a signal received from an antenna by using a duplexing method and transmits to the antenna a signal (i.e., DL signal) received from the TX modem 703.

The scheduler 709 performs data scheduling in consideration of a data transmission condition and an RS channel state, and provides the scheduling result to the message analyzer 713. Then, according to the scheduling result, the scheduler 709 generates a resource allocation message (e.g., MAP message or MAP IE) to be transmitted to MSs and RSs and transmits the generated resource allocation message to the TX modem 703.

Operations of the present invention will now be described with reference to FIG. 7.

Upon detecting an RS access, the controller 712 manages a network entry process for the RS. After performing the network entry process, the controller 712 instructs the message generator 711 to transmit a channel measurement request message. Under the control of the controller 712, the message generator 711 generates the channel measurement request message to be transmitted to the RS and transmits the channel measurement request message to the TX modem 703. As such, a MAC message is delivered to the TX modem 703 and is then transmitted through an antenna after being processed into a transmittable format.

After transmitting the channel measurement request message, the message analyzer 713 analyzes a channel measurement response message delivered from the RX modem 705 and provides the analysis result to the controller 712. Then, the controller 712 provides the duplexer 707 with channel information extracted from the channel measurement response message and sets a channel information update period for the RS. The channel information update period is set to a long period of time (e.g., one month, one year, etc.) under the assumption that the BS and the RS are in a Line Of Sight (LOS) state.

The duplexer 707 performs resource scheduling on the RS by using the channel information and delivers the scheduling result (i.e., resource allocation information) to the MAC layer unit 701. The duplexer 707 may use the RS channel information required in the initial access process for a predetermined long period of time whenever scheduling is performed for each frame. Alternatively, scheduling may be performed only once by using the channel information, and resources resulted from the scheduling may be allocated to the RS for a predetermined duration. In this case, the BS may transmit the resource allocation message to the RS only once at the beginning.

The controller 712 checks whether a channel information update event occurs for the RS. When the event occurs, the controller 712 instructs the message generator 711 to transmit a channel measurement update request message. The event may occur when a time corresponding to the channel information update period has elapsed or when an obstacle is disposed between the BS and the RS. Under the control of the controller 712, the message generator 711 generates the channel measurement update request message and delivers the generated message to the TX modem 703. As such, a MAC message is delivered to the TX modem 703 and is transmitted through an antenna after being processed into a transmittable format.

Meanwhile, after transmitting the channel measurement update request message, the message analyzer 713 analyzes a channel measurement update response message delivered from the RX modem 705 and provides the analysis result to the controller 712. Then, the controller 712 provides the duplexer 707 with channel information extracted from the channel measurement update response message and sets again the channel information update period of the RS. Subsequent operations of the duplexer 707 are the same as described above. Thus, detailed descriptions thereof will be omitted.

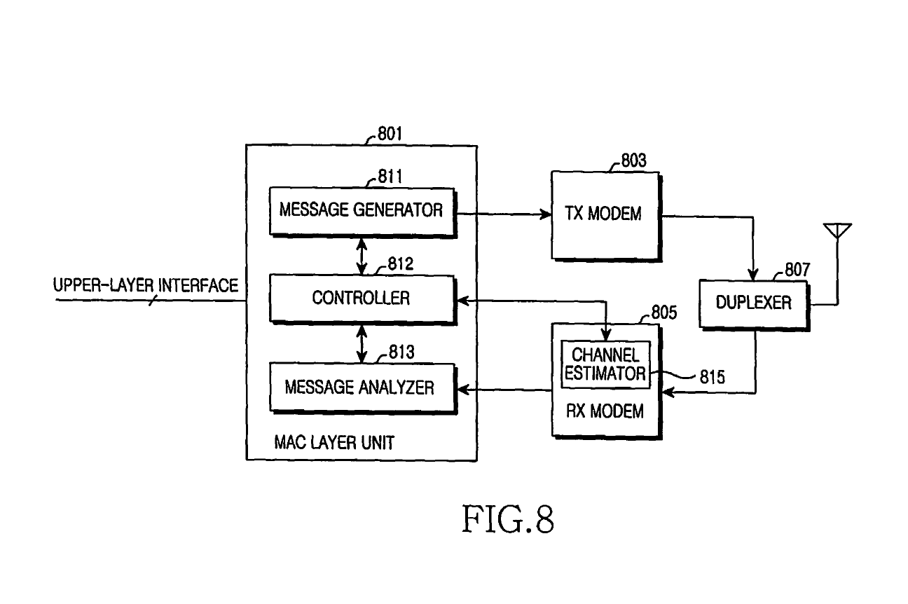

FIG. 8 is a block diagram illustrating a structure of an RS in a multi-hop relay mobile communication system according to an embodiment of the present invention.

Referring to FIG. 8, the RS includes a MAC layer unit 801 connected to an upper layer, a TX modem 803, an RX modem 805, and a duplexer 807. Operations of these elements are the same as those of the BS of FIG. 7, and thus detailed descriptions thereof will be omitted. The following descriptions will focus on operations of the present invention.

A controller 812 manages a network entry process for the BS during an initial access. After performing the network entry process, according to a message analysis result of a message analyzer 813, the controller 812 determines whether a channel measurement request message has been received. Upon receiving the channel measurement message, the controller 812 instructs a channel estimator 815 to estimate a channel according to information extracted from the channel measurement request message.

Then, the channel estimator 815 performs accurate channel estimation on an entire frequency band and reports the channel estimation result to the controller 812. In this case, the channel estimator 815 may divide the entire frequency band into a predetermined number of sub-bands, measure a CINR value for each sub-band, and report the measurement result to the controller 812.

Thereafter, the controller 812 provides a message generator 811 with channel estimation information obtained from the channel estimator 815 and instructs the message generator 811 to generate a channel measurement response message. Then, under the control of the controller 812, the message generator 811 generates the channel measurement response message, including the channel estimation information and delivers the generated message to the TX modem 803. As such, a MAC message is delivered to the TX modem 803 and is then transmitted through an antenna after being processed into a transmittable format.

When the message analysis result of the message analyzer 813 shows that the channel measurement update request message has been received, the controller 812 instructs the RX modem 805 to perform channel estimation and then provides channel estimation information reported from the RX modem 805 to the message generator 811. Then, the message generator 811 generates a channel measurement response message, including the channel estimation information and delivers the generated message to the TX modem 803.

As such, the RS measures a channel at the request of the BS and reports the measurement result to the BS. According to another embodiment, the RS may determine whether to measure the channel without having to receive the request of the BS and may report channel information to the BS.

For example, the controller 812 periodically receives a measured value (i.e., RSSI or SINR) of a BS signal from the RX modem 805. In this case, a difference between the measured value and a previously measured value is computed, and if the difference is greater than or equal to a predetermined threshold, it is determined that channel update is necessary. Alternatively, the controller 812 may periodically receive a measured value (i.e., a Bit Error Rate (BER) or a Frame Error Rate (FER)) of the BS signal from the RX modem 805. In this case, a difference between the measured value and a previous measured value is computed, and if the difference is greater than or equal to a predetermined threshold, it is determined that the channel update is necessary.

If it is determined that the channel update is necessary, the controller 812 instructs the message generator 811 to transmit a channel measurement update response message. Then, under the control of the controller 812, the message generator 811 generates the channel measurement update response message including channel estimation information and delivers the generated message to the TX modem 803. As such, a MAC message is delivered to the TX modem 803 and is transmitted through an antenna after being processed into a transmittable format.

According to the present invention, data scheduling is periodically performed on an RS (e.g., fixed RS or nomadic RS), of which channel variation is not significant, not for each frame, but for a long period of time, thereby reducing an overhead. The RS accurately estimates a channel for an entire frequency band and reports the estimation result to a BS. The BS uses the reported channel information for a long period of time, and can remove the overhead, which occurs when channel information is frequently reported as in the case of an MS. That is, since channel information of the RS is periodically updated with a predetermined long period of time or updated upon detecting channel variation, an overhead resulted from frequent update of channel information can be removed.

While the invention has been shown and described with reference to certain exemplary embodiments thereof, it will be understood by those skilled in the art that various changes in form and details may be made therein without departing from the spirit and scope of the invention as defined by the appended claims and their equivalents. Although the channel measurement request message is transmitted to the RS after a network entry process is performed in the aforementioned embodiment, the channel measurement request message may be transmitted to the RS during the network entry process or at a time when resource allocation is required.

Therefore, the scope of the invention is defined not by the detailed description of the invention but by the appended claims and their equivalents, and all differences within the scope will be construed as being included in the present invention.

What is claimed is:

1. A Base Station (BS) apparatus in a relay wireless communication system, the apparatus comprising:
a message generator for generating a channel measurement request message to be transmitted to a Relay Station (RS);
a Transmit (TX) modem for performing a physical layer processing on a message generated by the message generator and for transmitting the processed message;
a message analyzer for analyzing a channel measurement response message received from the RS and for obtaining channel estimation information; and
a scheduler for performing data scheduling by using the channel estimation information for a predetermined duration corresponding to a plurality of frames.

2. The apparatus of claim 1, wherein the channel measurement request message comprises at least one of a start frame number for starting channel measurement, a channel measurement duration, and a channel report period.

3. The apparatus of claim 1, wherein the channel measurement response message comprises at least one of the channel estimation information and a frame number for performing channel estimation.

4. The apparatus of claim 3, wherein, when an entire frequency band is divided into a predetermined number of sub-bands, the channel estimation information is at least one of channel estimation values for all sub-bands, channel estimation values for sub-bands having a channel state above a specific level, and channel estimation values for a predetermined number of sub-bands having a poor channel state.

5. The apparatus of claim 1, further comprising a controller for determines if a channel information update event for the RS occurs, for transmitting a channel measurement update request message to the RS upon detecting the event, and for controlling an operation of receiving a channel measurement update response message from the RS.

6. The apparatus of claim 5, wherein the channel information update event occurs when a time corresponding to a predetermined channel information update period has elapsed or when a geographical environment of the RS has changed.

7. A Relay Station (RS) apparatus in a relay wireless communication system, the apparatus comprising:
a message analyzer for analyzing a channel measurement request message received from a Base Station (BS) a channel estimator for estimating a channel for an entire frequency band according to the channel measurement request message;
a message generator for generating a channel measurement response message including channel estimation information provided from the channel estimator; and
a Transmit (TX) modem for processing a message provided from the message generator according to a transmission protocol and for transmitting the converted message,
wherein the channel estimation information reported to the BS is used in data scheduling for a frame duration corresponding to a plurality of frames.

8. The apparatus of claim 7, wherein the channel measurement request message comprises at least one of a start frame number for starting channel measurement, a channel measurement duration, and a channel report period.

9. The apparatus of claim 7, wherein the channel measurement response message comprises at least one of the channel estimation information and a frame number for performing channel estimation.

10. The apparatus of claim 9, wherein, when an entire frequency band is divided into a predetermined number of sub-bands, the channel estimation information is at least one of channel estimation values for all sub-bands, channel estimation values for sub-bands having a channel state above a specific level, and channel estimation values for a predetermined number of sub-bands having a poor channel state.

11. The apparatus of claim 7, further comprising a controller for controlling an operation of transmitting a channel measurement update response message to the BS when a channel measurement update request message is received from the BS or when a channel information update event occurs.

12. The apparatus of claim 11, wherein the channel information update event occurs when a variation of a signal strength of a signal received from the BS or a variation of a data error rate is greater than or equal to a predetermined threshold.

13. A communication method of a Base Station (BS) in a relay wireless communication system, the method comprising:
transmitting a channel measurement request message to a Relay Station (RS);
analyzing a channel measurement response message received from the RS and obtaining channel estimation information; and
allowing the channel estimation information to be used in data scheduling for a predetermined long period of time.

14. The method of claim 13, wherein the channel measurement request message comprises at least one element of a start frame number for starting channel measurement, a channel measurement duration, and a channel report period.

15. The method of claim 13, wherein the channel measurement response message comprises at least one of the channel estimation information and a frame number for performing channel estimation.

16. The method of claim 15, wherein, when an entire frequency band is divided into a predetermined number of sub-bands, the channel estimation information is at least one of channel estimation values for all sub-bands, channel estimation values for sub-bands having a channel state above a specific level, and channel estimation values for a predetermined number of sub-bands having a poor channel state.

17. The method of claim 13, further comprising:
determining if a channel information update event for the RS occurs;
upon detecting the event, generating a channel measurement update request message and transmitting the generated message to the RS;
obtaining channel estimation information by analyzing a channel measurement update response message received from the RS;
updating channel information of the RS into the obtained channel estimation information; and
allowing the updated channel estimation information to be used in data scheduling for a frame duration corresponding to a plurality of frames.

18. The method of claim 17, wherein the channel information update event occurs when a time corresponding to a predetermined channel information update period has elapsed or when a geographical environment of the RS has changed.

19. A communication method of a Relay Station (RS) in a relay wireless communication system, the method comprising:
receiving a channel measurement request message from a Base Station (BS);
estimating a channel for an entire frequency band according to the channel measurement request message; and
generating a channel measurement response message including channel estimation information and transmitting the generated message to the BS, wherein
the channel estimation information reported to the BS is used in data scheduling for a frame duration corresponding to a plurality of frames.

20. The method of claim 19, wherein the channel measurement request message comprises at least one of a start frame number for starting channel measurement, a channel measurement duration, and a channel report period.

21. The method of claim 19, wherein the channel measurement response message comprises at least one of the channel estimation information and a frame number for performing channel estimation.

22. The method of claim 21, wherein, when an entire frequency band is divided into a predetermined number of sub-bands, the channel estimation information is at least one of channel estimation values for all sub-bands, channel estimation values for sub-bands having a channel state better than a specific level, and channel estimation values for a predetermined number of sub-bands having a poor channel state.

23. The method of claim 19, further comprising:
determining if a channel measurement update request message is received from the BS;
upon receiving the channel measurement update request message, estimating a channel according to information included in the received message; and
generating a channel measurement update response message including the channel estimation information and transmitting the generated message to the BS.

24. The method of claim 19, further comprising:
determining if a channel information update event occurs;
upon detecting the event, estimating a channel for an entire frequency band; and
generating a channel measurement update response message including the channel estimation information and transmitting the generated message to the BS.

25. The method of claim 24, wherein the channel information update event occurs when a variation of a signal strength of a signal received from the BS or a variation of a data error rate is greater than or equal to a predetermined threshold.
